(19) United States
(12) Patent Application Publication
(10) Pub. No.: US 2015/0274322 A1
(43) Pub. Date: Oct. 1, 2015

(54) EMERGENCY LANDING APPARATUS FOR AIRCRAFT

(71) Applicant: Fahad ALAMMARI, Bristol, RI (US)

(72) Inventor: Fahad ALAMMARI, Bristol, RI (US)

(21) Appl. No.: 14/228,880

(22) Filed: Mar. 28, 2014

(51) Int. Cl. B64F 1/02

(52) U.S. Cl. CPC B64F 1/02

(57) ABSTRACT

An apparatus and method to assist in landing an aircraft without functional aircraft landing gear. The apparatus includes a runway with a low friction upper surface supporting the aircraft's weight and providing a low friction surface on which the aircraft slides until the aircraft comes to a stop. The apparatus also includes: wing receptacles that attach to the aircraft wings, resistance machines providing force to the wing receptacles in order to decelerate the aircraft, and cables connecting the resistance machines to the wing receptacles. A lubricant can be applied to the runway to decrease friction. The method includes the aircraft touching down on the low friction runway. The aircraft's momentum carries the aircraft wings into the wing receptacles that attach to the wings, and resistance machines apply a declaration force to the wing receptacles. The force is adjusted such that the aircraft stops within a safe distance.

### GRANT OF NON-EXCLUSIVE RIGHT

This application was prepared with financial support from the Saudia Arabian Cultural Mission, and in consideration therefore the present inventor(s) has granted The Kingdom of Saudi Arabia a non-exclusive right to practice the present invention.

### BACKGROUND

1. Field of the Disclosure

An apparatus for emergency landing of an aircraft that includes a mechanism independent from the aircraft landing gear for arresting the aircraft's motion, and a method for using the apparatus.

2. Description of the Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

Aircraft, such as airplanes, typical take off and land on runways with high friction landing surfaces such as tarmacadam (tarmac). The high friction runway enables aircraft to rapidly reduce velocity in a relatively short distance given the initial high speed of the aircraft at touchdown. In most aircraft this short stopping distance is enabled by brakes in the landing gear that are the dominant mechanism for decelerating the aircraft after the aircraft has touchdown. Additionally, other mechanisms such as air brakes, thrust reversers, and drogue parachutes may also aid in decelerating the aircraft, but the brakes in the landing gear are still the dominant mechanisms relied on to decelerate an aircraft.

When landing gear, for whatever reason, is rendered inoperable or otherwise malfunction, a major safety risk is created for the pilot and passengers. The risks are at least three-fold. First, there is a risk of injury due to sudden forces in the landing process directly injuring the passengers (e.g., whiplash). Second, there are risks of passengers being injured if the structural integrity of the aircraft is compromised (e.g., broken fragments and debris striking the passengers or expose fuel leaks exposed to heat or sparks resulting from the non-standard landing). Third, there is a risk of injury due to the likelihood that an aircraft does not stop within the length of the runway.

For example, consider the scenario that the landing gear is retracted after take-off and then fails to properly deploy during the landing process. In this case the fuselage of the aircraft will directly contact the runway upon touchdown. Friction between the runway and the fuselage may or may not be sufficient to stop the aircraft within the length of the runway. Even if friction the aircraft stops within a safe distance on the runway, the structural integrity of the fuselage will likely be compromised and potentially result in ruptured fuel tanks. The sparks and heat from friction as the aircraft fuselage grinds to a halt along the tarmac could ignite the leaking aircraft fuel. Alternatively, the sudden impact of the aircraft directly impacting the tarmac could by itself injury passengers. It could also result in asymmetric forces inducing the aircraft to rotate or spin around its center of gravity or veer from the runway and impact nearby structures. Finally, the impact could cause parts of the aircraft to break loose or kick up debris from the tarmac creating impact risks to the passengers and pilot.

These safety concerns justify the creation of safer alternatives for emergency landings than simply landing the aircraft on a traditional high friction runway. For example, it has been suggested the airports could maintain a long narrow channel or pond filled with water for emergency situations. Landing in the water would soften the landing while providing sufficient resistance to retard the aircraft and mitigate the risks of fire. Alternatively, it has been suggested that in emergency situations inflatable balloons, similar to airbags, could inflate from the bottom surface of an aircraft to provide an alternative landing means when the landing gear fails. By combining these airbag landing balloons with parachutes deployed from the top surface of the aircraft an emergency landing could be effectuated that would mitigate risks of injury to passengers and pilot.

As discussed later, the emergency landing apparatus proposed here provides two primary functions. First, a low friction surface is provided on which the bottom of the aircraft will slide. By using a low friction landing surface, many of the risks associated with emergency landing on tarmac can be avoided. Second, because the landing surface does not provide the means to slow the aircraft, alternative means is required to provide a decelerating force to the aircraft. There are other scenarios besides emergency landing where alternative deceleration means are required. For example, on an aircraft carrier ship the runways are too short to stop an aircraft using only friction between the aircraft and the runway. In the case of aircraft carriers and the like there are three primary methods for stopping aircraft within a short distance. First, the primary method uses a tailhook extending from an aircraft to catch hold of an arresting cable, and the arresting cable applies a deceleration force to the aircraft. The other two means are typically only used as fail safes at the end of runways. These methods often result in damage to the aircraft and thus are disadvantageous for everyday use, but are appropriate for emergency situations in order to avoid loss of life or injury to people. These two fail-safe methods are net barricades/barriers and engineered materials arresting systems. The net barricade acts like the arresting cable to apply a decelerating force to the aircraft except no special equipment, such as a tail hook, is required. Also the net attaches to the aircraft by enveloping the entire front of the aircraft rather than catching hold of a discrete part of the aircraft such as a tailhook. Engineered materials arresting systems are single use emergency systems positioned in an overrun section at the end of the runway. The engineered materials arresting systems are made from a collapsible material that fills the runway such that the material provides significant rolling resistance to the wheels in the landing gear quickly absorbing and dissipating the aircrafts forward momentum and bring the aircraft to a rapid stop.

None of the methods suggested so far combines the perfect blend of safety and affordability.

Generally the problem of emergency landing for an aircraft with non-functional landing gear can be expressed as two sub problems. The first is to smoothly transition the aircraft from a high rate of speed immediately after the aircraft touches down to stationary in a controlled fashion in order to avoid injury to pilot and passenger and minimize damage to the aircraft. The second sub problem is to decelerate to aircraft sufficiently rapidly so as to stop the aircraft within a predetermined length dictated by the length of the runway.

### SUMMARY

The foregoing paragraphs have been provided by way of general introduction, and are not intended to limit the scope of the following claims. The described embodiments, together with further advantages, will be best understood by reference to the following detailed description taken in conjunction with the accompanying drawings.

In one embodiment, the present disclosure provides an apparatus for landing an aircraft, the apparatus comprising an aircraft runway having a low friction top surface, a front portion, a first side, and second side. The apparatus further comprising a plurality of wing receptacles that receive respective wings of the aircraft, wherein the plurality of wing receptacles are arranged above the front portion of the aircraft runway with at least one wing receptacle fixed next to the first side of the runway and another wing receptacle fixed next to the second side of the runway. The apparatus further comprising a cable having a first end attached to one of the plurality of wing receptacles and a resistance machine that attaches to a second end of the cable, and the resistance machine provides force to the cable in order to slow and then stop the aircraft.

In one aspect, the present disclosure provides another wing receptacle, another cable having a first end attached to the one of the another wing receptacle, and another resistance machine that attaches to a second end of the another cable, and the another resistance machine provides force to the another cable in order to slow and then stop the aircraft.

In one aspect, the present disclosure provides that each of the plurality of wing receptacles comprises a flexible material that conforms to the outer surface of a respective wing of the aircraft, a top portion of the wing receptacle conforms to a top surface of the wing of the aircraft and a bottom portion of the wing receptacle conforms to a bottom surface of the wing of the aircraft; and the first end the cable having a top portion and a bottom portion, wherein the top portion of the cable attaches to the top portion of the respective wing receptacle, and the bottom portion of each cable attaches to the bottom portion of the respective wing receptacle.

In one aspect, the present disclosure provides that the flexible material is a net comprising webbing material from the group of nylon, polypropylene, polyester, Dyneema® and Kevlar®.

In one aspect, the present disclosure provides that each of the plurality of the wing receptacles is shaped as a hook, with a first end of the one of the plurality of wing receptacles unattached to the cable and a second end of the one of the plurality of wing receptacles attached to the cable.

In one aspect, the present disclosure provides that the resistance machines provides continuous force proportional to a mass of the aircraft so as to smoothly slow the aircraft and to stop the aircraft before the aircraft reaches an end of the runway.

In one aspect, the present disclosure provides a sensor that measures a force on the cable, a length of the cable, and a velocity of the cable; and circuitry configured to calculate, based on measurements from the sensor, a calculated force required to stop the aircraft within a predetermined distance, and to adjust an applied force applied to the cable such that the applied force corresponds to the calculated force to stop the aircraft within a predetermined distance.

In one aspect, the present disclosure provides that the resistance machines transmits a signal within a communication network, the signal including an indication of the force on the respective cable, the extended length of the cable, and velocity of the cable, and receives from the communication network another signal indicating the force to be applied to the cable.

In one aspect, the present disclosure provides that each of the plurality of resistance machines use fluid friction to provide the deceleration force to the aircraft.

In one aspect, the present disclosure provides that each of the plurality of resistance machines use magnets in relative motion to electrically conducting coils to provide the deceleration force to the aircraft.

In one aspect, the present disclosure provides a dispersing spigot that disperses lubricant on the low friction top surface of the aircraft runway.

In one aspect, the present disclosure provides a lubricant on the low friction top surface of the aircraft runway.

In one embodiment, the present disclosure provides a method of landing an aircraft comprising: providing an aircraft runway having a low friction top surface that supports the weight of the aircraft; receiving aircraft wings into a plurality of wing receptacles; and providing force from a resistance machine to a cable that attaches to the to the plurality of wing receptacles, wherein the provided force slows and then stops the aircraft.

The foregoing paragraphs have been provided by way of general introduction, and are not intended to limit the scope of the following claims. The described embodiments, together with further advantages, will be best understood by reference to the following detailed description taken in conjunction with the accompanying drawings.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1A shows a diagram for an emergency landing apparatus, where the aircraft is beginning the landing process;

FIG. 1B shows a diagram for an emergency landing apparatus, where the aircraft is at the end of the landing process;

FIG. 2 shows an emergency landing apparatus with a single resistance machine provided to decelerate the aircraft;

FIG. 3 shows an emergency landing apparatus where the wing receptacles have a hook shape;

FIG. 4A shows a wing receptacle having a hook shape, where the cable is connected to the wing receptacle underneath the wing;

FIG. 4B shows a wing receptacle having a hook shape, where the cable is connected to the wing receptacle above the wing;

FIG. 5 shows an emergency landing apparatus with lubricant disseminators arranged along the sides of the runway and lubricant dispersed on the top surface of the runway; and

FIG. 6 shows a schematic of a computational hardware included an emergency landing apparatus.

### DETAILED DESCRIPTION OF THE PREFERRED EMBODIMENTS

The apparatus and method proposed here for safely landing an aircraft with malfunctioning landing gear includes both a low friction landing surface and means for stopping the aircraft. The low friction landing surface both supports the weight of the aircraft and provides a low friction surface across which the bottom of the aircraft slides until it is safely be brought to a stop by the stopping means. The means for stopping the aircraft is realized by catching hold of the aircraft wings with wing receptacles and applying a deceleration force to the aircraft through this connection to the wings. Thus, the aircraft can be brought to a stop without relying on a resistive force between the bottom of the aircraft and the landing surface, which resistive force may be unstable or unreliable due to the malfunctioning landing gear.

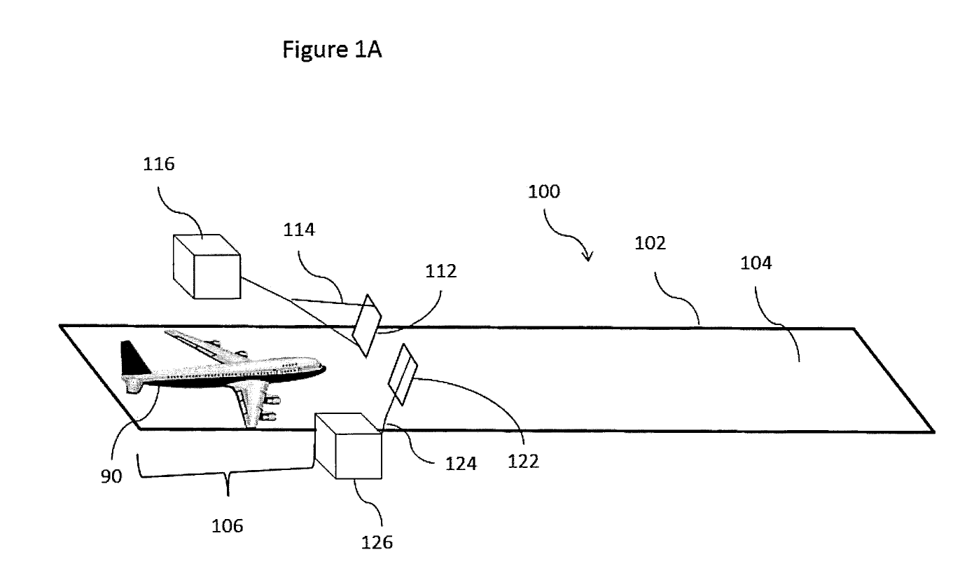

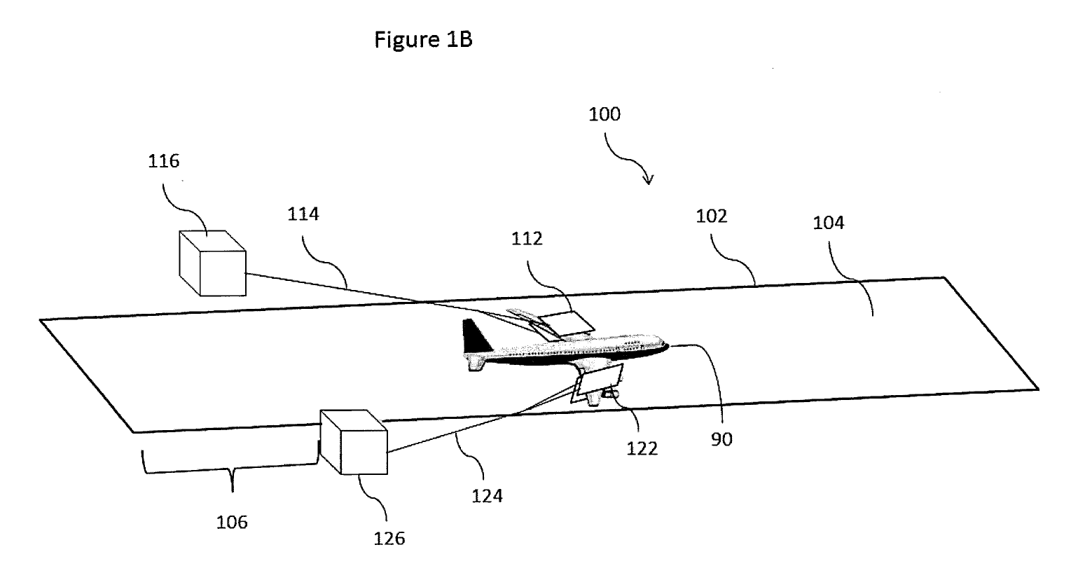

Referring now to the drawings, wherein like reference numerals designate identical or corresponding parts throughout the several views, FIG. 1A shows a perspective view of an aircraft emergency landing apparatus 100. The apparatus includes a runway 102 with a low friction top surface 104. In this context low friction means that the coefficient of friction between the low friction top surface 104 and a collection of secondary materials is less than 0.35; the secondary materials include common aircraft materials such as aluminum, painted aluminum, vulcanized rubber and the like. An aircraft 90 touches down on the front portion 106 of the runway 102. Resistance machines 116 and 126 are fixed adjacent to the runway near the front portion 106 of the runway 102. Each resistance machine 116 (126) is respectively attached to a wing receptacle 112 (122) via a cable 114 (124).

As shown in FIG. 1B, after touchdown the aircraft progresses along the low friction runway surface until the wings come into contact with the wing receptacles 112 and 122. The wing receptacles 112 and 122 then wrap around or otherwise attach to the wings. The resistance machines provide force to the cables, which then transfer the force along the cable to the wings of the aircraft via the contact between the wings and the wing receptacles. Because a low friction surface has been provided on the runway, the runway does not necessarily provide adequate resistance in order to stop the aircraft within a predetermined safe distance (e.g., the length of the runway). Therefore the resistance machines provide the deceleration force required to stop the aircraft within the predetermined safe distance.

The amount of force required to decelerate the aircraft will vary depending on the mass of the aircraft and the initial speed of the aircraft at the time when the wings first contact the wing receptacles 112 and 122. If too much deceleration force is applied, the risk of injury is increased by decelerating the aircraft too rapidly. If too little deceleration force is applied, then the aircraft will not stop within the predetermined safe distance therefore also increasing the risk of injury. Because the apparatus 100 can be used with different aircraft, the deceleration force provided by the resistance machines will change according to the type of aircraft and the landing parameters and conditions (e.g., the initial speed of the aircraft).

In one embodiment the deceleration force applied by the resistance machines will be adjusted before the aircraft lands by changing the operating parameters of the resistance machines. For example, the aircraft pilot could communicate to operators on the ground the type of aircraft and mass of the aircraft. The operators on the ground can then changes force settings in the resistance machines either by manual changing the settings or electronically changing the settings (e.g., by wireless communication or a computer interface changing a value stored in a computer memory).

In an alternative embodiment, the resistance machines will include sensors that can measure the length of extended cable, the velocity of the cable, and the force on the cable. The resistance machines will use feedback from these sensors to adjust and correct the deceleration force applied to each cable. Based on the sensor measurements the resistance machines will control the force on the cable to maintain the stability of the aircraft and ensure that the aircraft smoothly decelerates and stops within the safe distance.

In one embodiment, the resistance machines will be part of a communication network in which each resistance machine will communicate to the network the sensor measurements from the resistance machine, and the force applied by each resistance machine will be coordinated by the network to ensure the appropriate forces are applied to each wing in order to maintain stable motion of the aircraft along the runway and to minimize rotation of the aircraft about its center of gravity and to ensure that the aircraft smoothly decelerates and stops within the safe distance.

In one embodiment the communication network will use control theory to optimize the force applied to each wing based on the feedback from the sensors, where the control theory can be based on a proportion-integral-derivative controller, root locus analysis, H-infinity analysis, etc.

In one embodiment, each resistance machine uses an electromagnetic motor/generator coupled to a transformer and resistive element to control the deceleration force applied to the cable. In a second embodiment, each resistance machine uses fluid friction to provide the deceleration force. The fluid friction can be provided by a piston moving through a channel containing fluid, such as water. In one embodiment the amount of fluid friction is determined by the size of the channel relative to the size of the piston moving through the channel and/or the size of holes in the side wall of the channel where the holes allow fluid flow from the channel to an outside space. By changing tapering the size of the channel along its length the resistive force applied to the piston and cable changes as a function of the piston position along the channel. Alternatively, by changing the size and spacing of the holes in the channel wall the fluid resistance can also be changed.

In one embodiment, the fluid friction can be provided by a turbine rotating in a fluid, such as water or air, and variable gear ratios provided between the fluid turbine and a wheel around which the cable is wound can be used to adjust the deceleration force provided to the aircraft wing via the cable.

One of ordinary skill in the art will recognize that other methods can be used to provide variable deceleration force from the resistance machines to the aircraft wings. These other methods include mechanisms that are energy conserving and dissipative or a combination of energy conserving and dissipative.

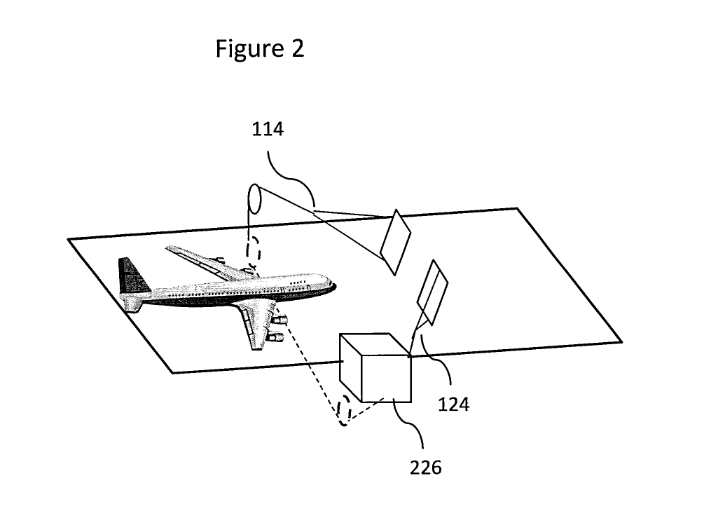

In one embodiment, as shown in FIG. 2, a single resistance machine 226 provides a deceleration force to both cables 114 and 124. The resistance machine 226 can be connected to cable 114 via a pulley system that runs under the runway as shown in FIG. 2. This arrangement simplifies the apparatus by eliminating the requirement for communication between multiple resistance machines. By using a single resistance machine the length of extended cable (i.e., the length of each cable beyond the cable's initial position) will be equal for cables connected to wing receptacles on both sides of the aircraft thus minimizing the risk of the aircraft twisting or rotating about its center of gravity.

In an alternative embodiment, one of ordinary skill in the art would recognize that more than one resistance machine on each side of the runway could be used. The advantage of such an arrangement would be redundancy in case one of the resistance machines failed. A second advantage would be that, if one resistance machine per side provided insufficient deceleration force to stop the aircraft within the safe distance, then multiple resistance machines might be sufficient per side where a single resistance machine was insufficient.

In one embodiment, as shown in FIG. 1A and FIG. 1B, the wing receptacles are a flexible material such as a rubberized canvas composite, webbing (made out of polypropylene, polyester, Dyneema® and Kevlar®, etc.), cargo net, etc. The end of each cable attaching to the wing receptacle is bifurcated to attach to two opposite sides of the wing receptacle. When a wing is received into a wing receptacle, a top portion of the wing receptacle wraps around and conforms to t the top surface of the wing lying flat against to the top surface of the wing, and a bottom portion of the wing receptacle wraps around and conforms to t the bottom surface of the wing and lies against the bottom surface of the wing. The middle portion of the wing receptacle conforms to the front surface of the wing and connects the top portion of the wing receptacle to the bottom portion of the wing receptacle. An example of this type of wing receptacle is shown in FIG. 1A and FIG. 1B.

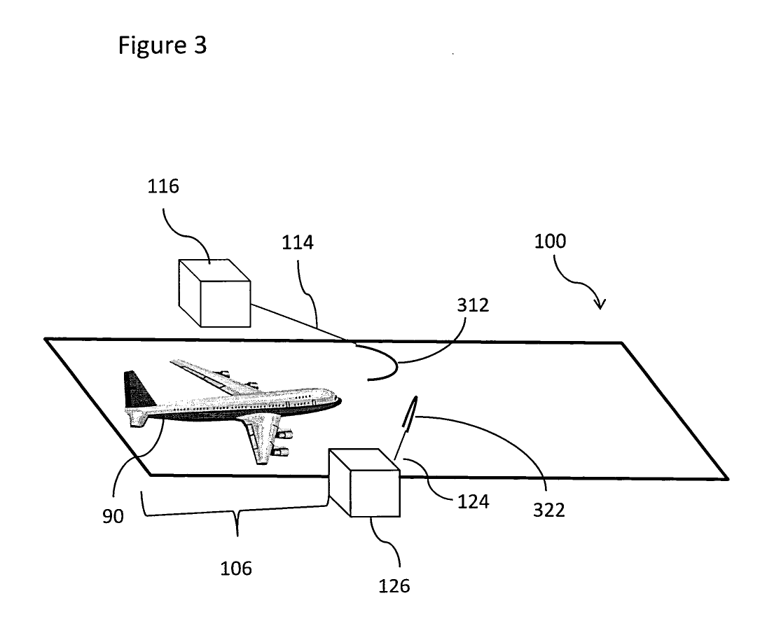

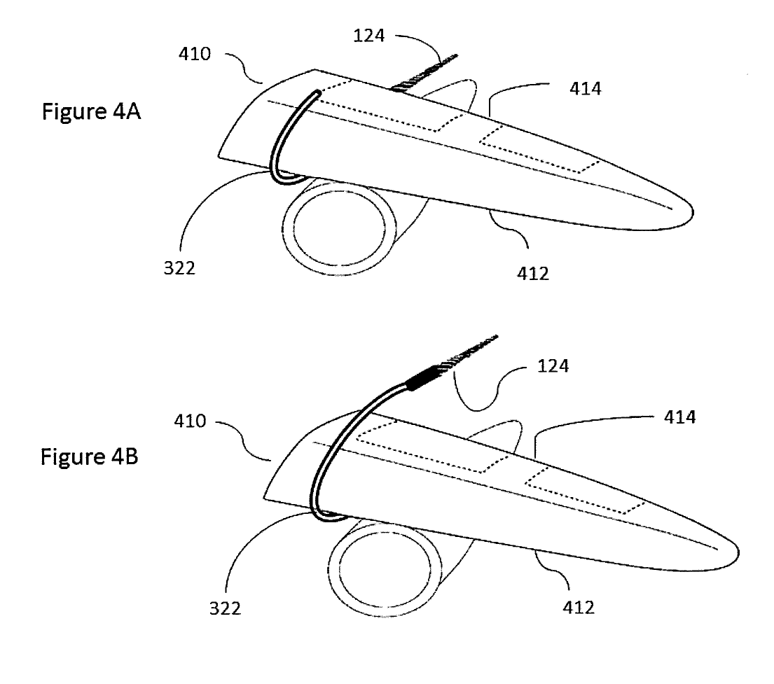

In an alternative embodiment of the wing receptacles, as shown in FIG. 4A and FIG. 4B, each wing receptacle (e.g., 322) can be arranged in a hook shape and the cable (e.g., 124) can be attached to a single end of the wing receptacle, as shown in shown in FIG. 3, FIG. 4A, and FIG. 4B. As shown in FIG. 4A, the hook shaped wing receptacle attaches to the front surface 412 of the wing 410, and the cable attaches to the wing receptacle 322 and extends past the back surface of the wing 414 towards the resistance machine. In FIG. 4A the cable 124 is shown to attach to the wing receptacle 322 at the end of the wing respectable 322 that is positioned under the wing, and in FIG. 4B the cable 124 is shown to attach to the wing receptacle 322 at the end of the wing respectable 322 that is positioned over the wing.

In one embodiment of the hooked shaped wing receptacles, the inner radius of curvature of the hook, which contacts the wing, can be lined with a compressible or otherwise deformable/elastic material in order to cushion the impact when the wing first contacts the wing receptacle. This compressible/elastic material can be a collapsible semi-rigid foam. Alternatively, the compressible/elastic material can be an elastomeric band stretched between diametric sides of each wing receptacle, or the like. Moreover, although the structural material of the hooked shaped wing receptacles is substantial rigid in order to maintain general curved shape such that the wing receptacle circumscribes the front surface of the wing in order to remain attached to the wing, the structural material of the wing receptacles can also be malleable and pliable in order to limit damage to the wing and to limit damage to the wing receptacles when the wing impacts wing receptacle.

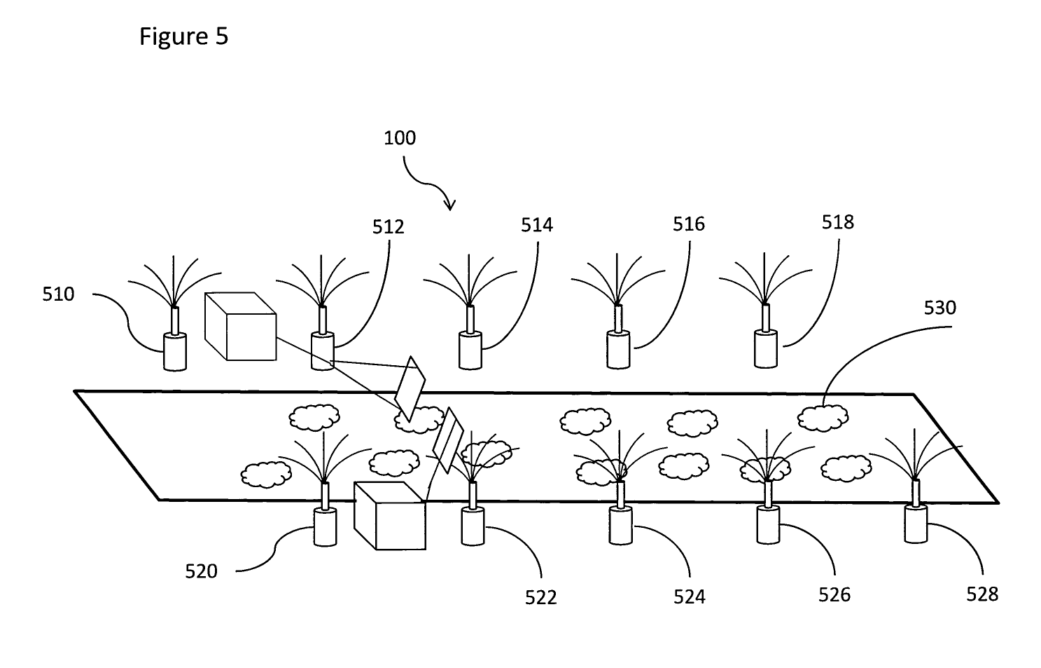

In one embodiment, as shown in FIG. 5, the emergency landing apparatus includes lubricant 530 on the low friction upper surface of the runway and disseminators 510, 512, 514, 516, 518, 520, 522, 524, 526, and 528 to disperse lubricant onto the runway. These disseminators can be nozzles for dispersing liquids, blowers for dispersing powders, disseminators for dispersing foams, etc. Additionally, the disseminators could be mounted on a mobile platform, or the disseminators could be fixed to the ground.

In one embodiment, the lubricant can be a wet lubricant such as water, fire retardant foam, oil, grease, etc. Alternatively, the lubricant can be a dry lubricant such as sand, kitty litter, ice, dirt, small glass balls, a painted surface, etc.

In one embodiment, the edges of the low friction top surface of the runway are raised relative to the center of the low friction top surface of the runway in order that the lubricant will pool on low friction top surface of the runway and not flow off the low friction top surface of the runway.

In one embodiment, the lubricant could be something that is not disseminated and the emergency landing apparatus 100 does not include lubricant disseminating devices. For example, the lubricant could be continuously present on the runway. In one exemplary embodiment the lubricant can be vegetative matter such as wood chips, grass, etc.

In one embodiment the emergency landing apparatus 100 includes computational hardware that can perform the tasks of calculating and controlling the desired deceleration force and the tasks of network communications among the resistance machines and other networks. In some embodiments each resistance machine will include computational hardware, and in other embodiments portions of the computational hardware will be located with the individual resistance machines while other portions of the computational hardware will be located at a central control station.

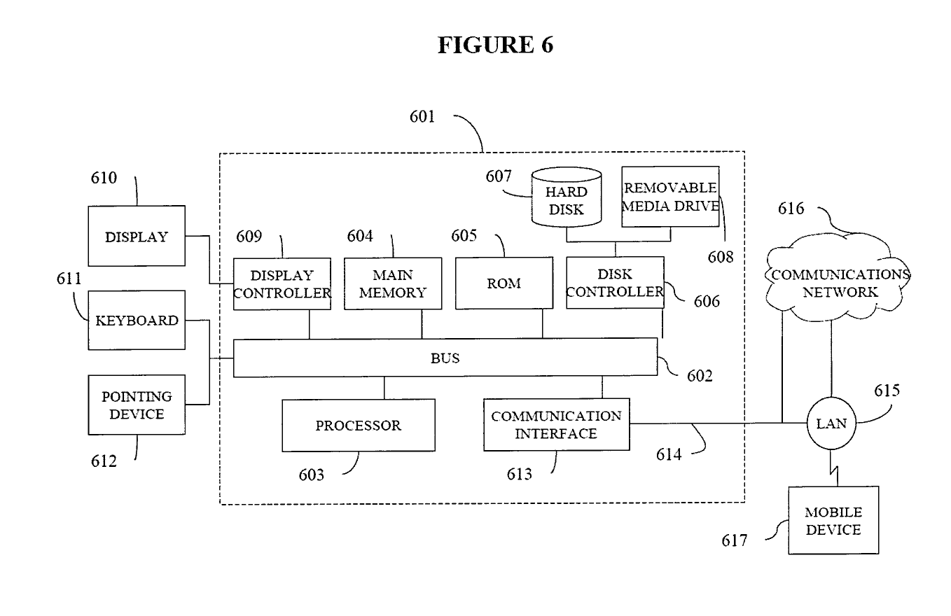

Next, a hardware description of the computational hardware of the emergency landing apparatus 100 according to exemplary embodiments is described with reference to FIG. 6. In FIG. 6, the emergency landing apparatus 100 includes a CPU 600 which performs the processes described above. The process data and instructions may be stored in memory 602. These processes and instructions may also be stored on a storage medium disk 604 such as a hard drive (HDD) or portable storage medium or may be stored remotely. Further, the claimed advancements are not limited by the form of the computer-readable media on which the instructions of the inventive process are stored. For example, the instructions may be stored on CDs, DVDs, in FLASH memory, RAM, ROM, PROM, EPROM, EEPROM, hard disk or any other information processing device with which the emergency landing apparatus 100 communicates, such as a server or computer.

Further, the claimed advancements may be provided as a utility application, background daemon, or component of an operating system, or combination thereof, executing in conjunction with CPU 600 and an operating system such as Microsoft Windows 7, UNIX, Solaris, LINUX, Apple MAC-OS and other systems known to those skilled in the art.

CPU 600 may be a Xenon or Core processor from Intel of America or an Opteron processor from AMD of America, or may be other processor types that would be recognized by one of ordinary skill in the art. Alternatively, the CPU 600 may be implemented on an FPGA, ASIC, PLD or using discrete logic circuits, as one of ordinary skill in the art would recognize. Further, CPU 600 may be implemented as multiple processors cooperatively working in parallel to perform the instructions of the inventive processes described above.

The emergency landing apparatus 100 in FIG. 6 also includes a network controller 606, such as an Intel Ethernet PRO network interface card from Intel Corporation of America, for interfacing with a network. As can be appreciated, the network can be a public network, such as the Internet, or a private network such as an LAN or WAN network, or any combination thereof and can also include PSTN or ISDN sub-networks. The network can also be wired, such as an Ethernet network, or can be wireless such as a cellular network including EDGE, 3G and 4G wireless cellular systems. The wireless network can also be WiFi, Bluetooth, or any other wireless form of communication that is known.

The emergency landing apparatus 100 further includes a display controller 608, such as a NVIDIA GeForce GTX or Quadro graphics adaptor from NVIDIA Corporation of America for interfacing with display 610, such as a Hewlett Packard HPL2445w LCD monitor. A general purpose I/O interface 612 interfaces with a keyboard and/or mouse 614 as well as a touch screen panel 616 on or separate from display 610. General purpose I/O interface also connects to a variety of peripherals 618 including printers and scanners, such as an OfficeJet or DeskJet from Hewlett Packard.

A sound controller 620 is also provided in the device, such as Sound Blaster X-Fi Titanium from Creative, to interface with speakers/microphone 622 thereby providing sounds and/or music.

The general purpose storage controller 624 connects the storage medium disk 604 with communication bus 626, which may be an ISA, EISA, VESA, PCI, or similar, for interconnecting all of the components of the device. A description of the general features and functionality of the display 610, keyboard and/or mouse 614, as well as the display controller 608, storage controller 624, network controller 606, sound controller 620, and general purpose I/O interface 612 is omitted herein for brevity as these features are known.

Obviously, numerous modifications and variations of the present invention are possible in light of the above teachings. It is therefore to be understood that within the scope of the appended claims, the invention may be practiced otherwise than as specifically described herein.

Thus, the foregoing discussion discloses and describes merely exemplary embodiments of the present invention. As will be understood by those skilled in the art, the present invention may be embodied in other specific forms without departing from the spirit or essential characteristics thereof. Accordingly, the disclosure of the present invention is intended to be illustrative, but not limiting of the scope of the invention, as well as other claims. The disclosure, including any readily discernible variants of the teachings herein, define, in part, the scope of the foregoing claim terminology such that no inventive subject matter is dedicated to the public.

1. An apparatus for landing an aircraft comprising:
an aircraft runway having a low friction top surface, a front portion, a first side, and second side;
a plurality of wing receptacles that receive respective wings of the aircraft, wherein the plurality of wing receptacles are arranged above the front portion of the aircraft runway with at least one wing receptacle fixed next to the first side of the runway and another wing receptacle fixed next to the second side of the runway;
a cable having a first end attached to one of the plurality of wing receptacles; and
a resistance machine that attaches to a second end of the cable, and the resistance machine provides force to the cable in order to slow and then stop the aircraft.

2. The apparatus according to claim 1 further comprising:
another wing receptacle;
another cable having a first end attached to the one of the another wing receptacle; and
another resistance machine that attaches to a second end of the another cable, and the another resistance machine provides force to the another cable in order to slow and then stop the aircraft.

3. The apparatus according to claim 1, wherein
each of the plurality of wing receptacles comprises a flexible material that conforms to the outer surface of a respective wing of the aircraft, a top portion of the wing receptacle conforms to a top surface of the wing of the aircraft and a bottom portion of the wing receptacle conforms to a bottom surface of the wing of the aircraft; and
the first end the cable having a top portion and a bottom portion, wherein the top portion of the cable attaches to the top portion of the respective wing receptacle, and the bottom portion of each cable attaches to the bottom portion of the respective wing receptacle.

4. The apparatus according to claim 3, wherein
the flexible material is a net comprising webbing material from the group of nylon, polypropylene, polyester, Dyneema® and Kevlar®.

5. The apparatus according to claim 1, wherein
each of the plurality of the wing receptacles is shaped as a hook, with a first end of the one of the plurality of wing receptacles unattached to the cable and a second end of the one of the plurality of wing receptacles attached to the cable.

6. The apparatus according to claim 5, wherein
each of the plurality of wing receptacle includes a compressible material, wherein the compressible material is disposed on respective contact surfaces of the plurality of wing receptacles that are arranged to contact the aircraft wing.

7. The apparatus according to claim 1, wherein
the resistance machines provides continuous force proportional to a mass of the aircraft so as to smoothly slow the aircraft and to stop the aircraft before the aircraft reaches an end of the runway.

8. The apparatus according to claim 7, further comprising:
a sensor that measures a force on the cable, a length of the cable, and a velocity of the cable; and
circuitry configured to calculate, based on measurements from the sensor, a calculated force required to stop the aircraft within a predetermined distance, and to adjust an applied force applied to the cable such that the applied force corresponds to the calculated force to stop the aircraft within a predetermined distance.

9. The apparatus according to claim 8, wherein
the resistance machines transmits a signal within a communication network, the signal including an indication of the force on the respective cable, the extended length of the cable, and velocity of the cable, and receives from the communication network another signal indicating the force to be applied to the cable.

10. The apparatus according to claim 1, wherein
each of the plurality of resistance machines use fluid friction to provide the deceleration force to the aircraft.

11. The apparatus according to claim 1, wherein
each of the plurality of resistance machines use magnets in relative motion to electrically conducting coils to provide the deceleration force to the aircraft.

12. The apparatus according to claim 1, further comprising:
a dispersing spigot that disperses lubricant on the low friction top surface of the aircraft runway.

13. The apparatus according to claim 1, further comprising:
a lubricant on the low friction top surface of the aircraft runway.

14. The apparatus according to claim 13, wherein
the lubricant is water.

15. The apparatus according to claim 13, wherein
the lubricant is a fire suppressant lubricant.

16. The apparatus according to claim 15, wherein
the lubricant is a fire suppressant foam.

17. A method of landing an aircraft comprising:
providing an aircraft runway having a low friction top surface that supports the weight of the aircraft;
receiving aircraft wings into a plurality of wing receptacles; and
providing force from a resistance machine to a cable that attaches to the to the plurality of wing receptacles, wherein the provided force slows and then stops the aircraft.
